(19) United States
(12) Patent Application Publication
(10) Pub. No.: US 2004/0061965 A1
(43) Pub. Date: Apr. 1, 2004

(54) Hard disk drive having hole cover for blocking electromagnetic wave

(75) Inventors: Jae-Deog Cho, Suwon-si (KR); Chul -Woo Lee, Seongnam-si (KR); Kwang-Kyu Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/661,525

(22) Filed: Sep. 15, 2003

(30) Foreign Application Priority Data
Sep. 16, 2002 (KR) 2002-56231

(51) Int. Cl. G11B 15/18

(52) U.S. Cl. 360/69

(57) ABSTRACT

A hard disk drive with a housing having a base plate and a cover plate. A spindle motor is installed on the base plate. A disk is installed on the spindle motor to store data. An actuator has a magnetic head to record and reproduce data on the disk, is installed on the base plate, and is pivoted by a voice coil motor. A printed circuit board is installed on a bottom surface of the base plate. A through hole, where servo track information is recorded on a recording surface of the disk, is positioned in the base plate, and a hole cover made of a metal plate exhibiting an electric conductivity and covering the through hole, is attached to the bottom surface of the base plate to block an electromagnetic wave generated by the printed circuit board from being transferred to the inside of the housing.

### CROSS-REFERENCE TO RELATED APPLICATIONS

This application claims the priority of Korean Patent Application No. 2002-56231 filed Sep. 16, 2002, in the Korean Intellectual Property Office, the disclosure of which is incorporated herein in its entirety by reference.

### BACKGROUND OF THE INVENTION

1. Field of the Invention

The present invention relates to a hard disk drive, and more particularly, to a hard disk drive that can effectively prevent a preamplifier and a magnetic head installed on an actuator, from being damaged by an electromagnetic wave generated by a printed circuit board.

2. Description of the Related Art

Hard disk drives (HDDs) are auxiliary memory devices for a computer to read and record data from and on a disk using a magnetic head.

FIG. 1 is a plan view illustrating a conventional hard disk drive. Referring to the drawing, the conventional hard disk drive includes a magnetic disk (hard disk) 20, which is a recording medium where data is recorded, and a magnetic head (not shown), which records data on a recording surface of the disk 20 and/or reproduces the recorded data. In the past, two or more disks have been installed in a hard disk drive to increase the data storage capacity. However, as a surface recording density of a disk sharply increases recently, a single disk can contain a sufficient amount of data. Accordingly, hard disk drives having a single disk have recently been developed. Also, a data recording surface can be formed on both sides of the disk 120, or only one side thereof, for example, a lower surface thereof.

The disk 20 is rotated by a spindle motor 30 installed on a base plate 10. Servo track information indicating the position of information to be recorded is recorded on hundreds of thousands of tracks located on the recording surface. An actuator 40 is installed on the base plate 10, and is capable of pivoting. The magnetic head is mounted on a slider 48 installed at one end portion of the actuator 40. The actuator 40 has an arm 44 that is pivoted around a pivot shaft 42 by a voice coil motor 50, and a suspension 46 coupled to one end portion of the arm 44, and supporting the slider 48 to be elastically biased toward the recording surface of the disk 20.

When power to the hard disk drive is turned off, the slider 48 is placed on the surface of the disk 20 by an elastic force of the suspension 46. When the power is turned on and the disk 20 begins to rotate, aerodynamic lift is generated, and accordingly the slider 48 is lifted to a predetermined height. The slider 48 in a lifted state is moved toward the recording surface of the disk 20 as the actuator 40 pivots. As a result, the magnetic head mounted on the slider 48 traces a particular track on the recording surface of the disk 20 and records and/or reproduces data.

A through hole 70, in which a push-pin (not shown) used in recording servo track information on the recording surface is inserted, is located in the base plate 10. After the servo track information is completely recorded, a printed circuit board (PCB) (not shown), on which a plurality of chips, such as an LSI (large scale integrated circuit), are mounted, is installed on a bottom surface of the base plate 10.

But in the conventional hard disk drive having the above structure, an electromagnetic wave having a predetermined frequency is generated by the LSI mounted on the PCB. The electromagnetic wave is transferred through the base plate 10 via the through hole 70. The electromagnetic wave transferred through the base plate 10 affects the magnetic head installed at the actuator 40, and also affects an FPCB (flexible printed circuit board) 64 and a preamplifier 62, which apply a current signal to the magnetic head and amplify a reproduction signal from the magnetic head, respectively. The effect is the generation of noise.

As shown in FIG. 4, in the conventional hard disk drive, significant noise is generated in a frequency area different from that of the reproduction signal, due to the above-described reasons. Accordingly, a bit error rate (BER) due to noise increases in the reproduced data. In particular, as shown in FIG. 5, the BER of a reproduction signal appears high when the magnetic head is disposed in a middle portion between a central portion and an edge portion of the disk 20. This is because at this position, the magnetic head, the preamplifier 62, and the FPCB 64 are closest to the through hole 70.

To prevent the disk 20 and the magnetic head from becoming contaminated by dust or moisture introduced from the outside via the through hole 70, a hole cover 72 covering the through hole 70 is attached to the bottom surface of the base plate 10. But since the conventional hole cover 72 is made of a plastic plate coated with metal powder such as aluminum, the metal powder coating is not sufficiently dense to block the electromagnetic wave. Also, since it is difficult for current to flow through the conventional hole cover 72, an effect of attenuation of an electromagnetic wave due to eddy current loss cannot be obtained. Thus, the hole cover 72 provided in the conventional hard disk drive cannot block the electromagnetic wave generated by the LSI of the PCB and transferred through the base plate 10 via the through hole 70.

### SUMMARY OF THE INVENTION

To solve the above and/or other problems, an embodiment of the present invention provides a hard disk drive having a hole cover preventing an electromagnetic wave generated by a PCB from being transferred toward a magnetic head and a preamplifier installed on an actuator, via a through hole positioned in a base plate.

According to an aspect of the present invention, the hard disk drive has: a housing with the base plate and a cover plate; a spindle motor installed on the base plate; a disk installed on the spindle motor to store data; an actuator having the magnetic head to record and/or reproduce data on the disk, that is installed on the base plate, and is pivoted by a voice coil motor; and the printed circuit board installed on a bottom surface of the base plate, wherein the through hole where servo track information is recorded on a recording surface of the disk, is positioned in the base plate, and the hole cover, made of a metal plate exhibiting an electric conductivity and covering the through hole, is attached to a bottom surface of the base plate, to block an electromagnetic wave generated by the printed circuit board from being transferred to an inside of the housing.

According to one aspect, eddy current is generated in the hole cover by the electromagnetic wave, and the electromagnetic wave is reduced by energy loss due to the eddy current.

According to one aspect, the hole cover is made of an aluminum plate. According to one aspect, the hole cover is attached to the bottom surface of the base plate using an adhesive. According to another aspect, the hole cover is attached to the bottom surface of the base plate using an adhesive tape covering the hole cover.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1 is a plan view illustrating a conventional hard disk drive;

FIG. 2 is an exploded perspective view illustrating a hard disk drive having a hole cover according to an embodiment of the present invention;

FIG. 3 is a vertical sectional view of the hard disk drive of FIG. 2;

FIG. 4 is a graph showing amplitudes of a reproduction signal and noise in the hard disk drive of FIG. 2, in comparison with the conventional technology; and

FIG. 5 is a graph showing a BER of a reproduction signal according to the position of the magnetic head in the hard disk of FIG. 2, in comparison with the conventional technology.

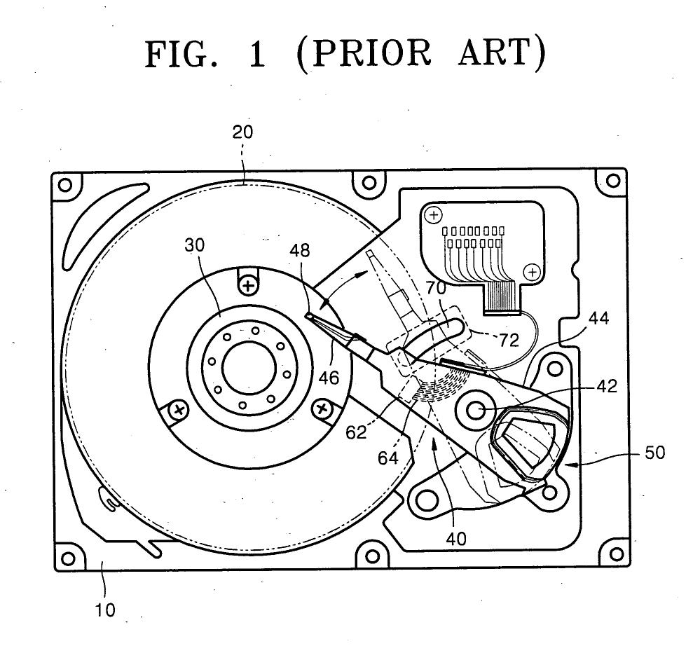

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

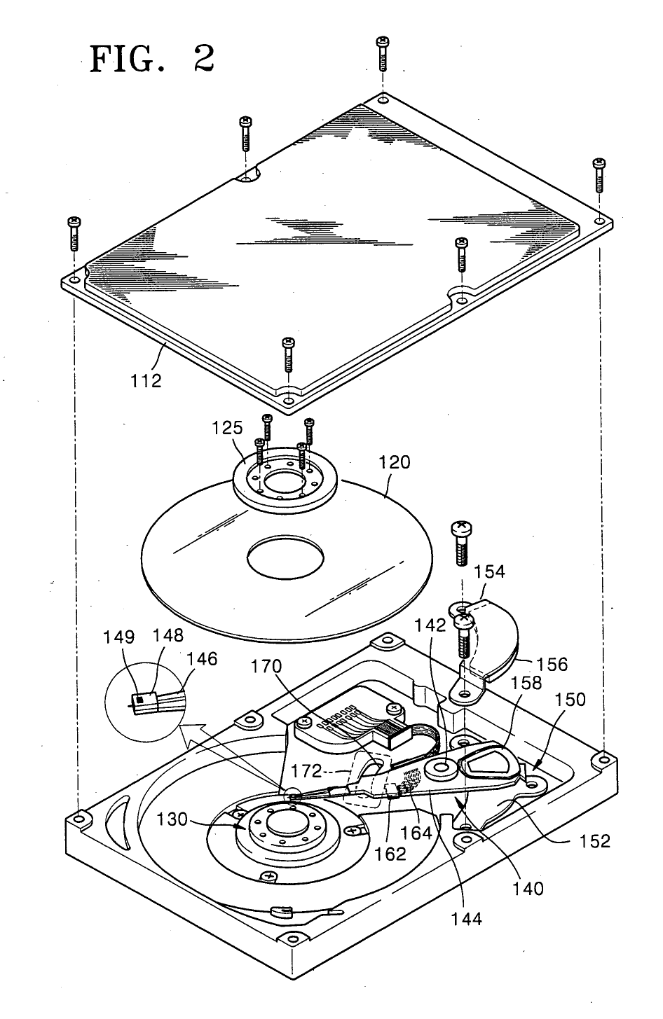

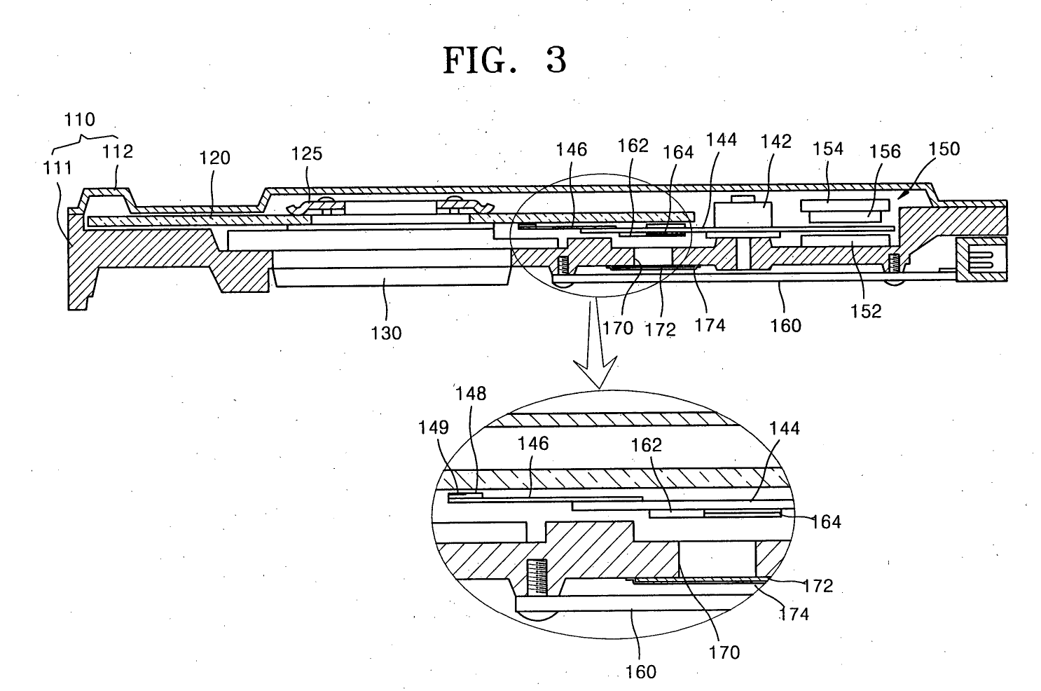

Referring to FIGS. 2 and 3, a hard disk drive according to an embodiment of the present invention has a housing 110, in which a magnetic disk 120, a spindle motor 130, an actuator 140 having a magnetic head 149, and a voice coil motor 150 are installed.

The housing 110 is installed in a main body of a computer (not shown) and includes a base plate 111 supporting the spindle motor 130 and the actuator 140, and a cover plate 112 coupled to an upper portion of the base plate 111 to enclose and protect the disk 120.

According to one aspect, the housing 110 is manufactured of stainless steel. According to another aspect, the housing 110 is made of aluminum.

According to one aspect, there is one disk 120 installed in the housing 110. Further, a data recording surface is positioned on a lower surface of the disk 120. But, the present invention is not limited to a case in which a single disk is provided. According to another aspect, there are at least two disks 120 provided.

The spindle motor 130 rotates the disk 120, and is fixed to the base plate 111. A clamp 125, preventing escape of the disk 120, is coupled to an upper end portion of the spindle motor 130.

The actuator 140 to record and reproduce data, is installed on the base plate 111 and is capable of pivoting. The actuator 140 has an arm 144 coupled to a pivot shaft 142, and a suspension 146 installed at one end portion of the arm 144, to support a slider 148, on which the magnetic head 149 is mounted, and which is elastically biased toward the surface of the disk 120. A flexible printed circuit board (FPCB) 164 and a preamplifier 162, to apply a current signal to the magnetic head 149 and amplify a reproduction signal from the magnetic head 149, respectively, are installed on the arm 144 of the actuator 140. According to one aspect, the FPCB 164 and the preamplifier 162 are attached to a side surface of the arm 144. According to another aspect however, to lower a height of the actuator 140, the FPCB 164 and the preamplifier 162 are installed on a lower surface of the arm 144, that is, on a surface facing the base plate 111, as shown in the drawings.

The actuator 140 is pivoted by the voice coil motor 150. The voice coil motor 150 has: a coil 158 coupled to an other end portion of the arm 144 of the actuator 140; upper and lower yokes 154 and 152 installed above and under the coil 158, respectively; and at least one magnet 156 attached to at least one of the upper and lower yokes 154 and 152.

A printed circuit board (PCB) 160, on which a plurality of chips, such as an LSI (large scale integrated circuit), to drive and control constituent elements of the hard disk drive, is installed on a lower surface of the base plate 111. Also, a through hole 170 into which a push-pin (not shown), used to control pivoting of the actuator 140 when servo track information is recorded on the recording surface on the lower surface of the disk 120, is positioned in the base plate 111. When the servo track information is recorded, the push-pin penetrates the through hole 170, to interfere with the arm 144 of the actuator 140.

After the servo track information is completely recorded on the recording surface of the disk 120, a hole cover 172 covering the through hole 170 is attached to the lower surface of the base plate 111. An electromagnetic wave of a predetermined frequency is generated by the LSI mounted on the PCB 160. Since the electromagnetic wave affects the magnetic head 149, the preamplifier 162, and the FPCB 164 installed on the actuator 140, it needs to be blocked.

According to one aspect, the hole cover 172 is a metal plate exhibiting an electric conductivity. Thus, eddy current can be generated in the hole cover 172 by the electromagnetic wave generated by the LSI mounted on the PCB 160. When a magnetic flux changes in a conductive body, an electromotive force is generated. The electromotive force makes current flow in eddy form in the conductive body, and the current is referred to as eddy current. Heat is generated in the conductive body by the eddy current and a resistance of the conductive body, so that loss of energy occurs, which is referred to as eddy current loss. Thus, an effect of the electromagnetic wave can be reduced, or nearly eliminated by the eddy current loss in the hole cover 172. As a result, the electromagnetic wave passing the hole cover 172 and reaching the magnetic head 149, the preamplifier 162, and the FPCB 164 is very weak, and thus the noise generated by the electromagnetic wave is reduced.

According to one aspect, to perform the above function, the hole cover 172 is made of a metal plate exhibiting an appropriate electric conductivity and an appropriate resistance, for example, aluminum. Also, considering that the amount of the eddy current and the heat loss due to resistance, the thickness of the hole cover 172 is determined so that the electromagnetic wave is sufficiently reduced.

Also, the hole cover 172 prevents the disk 120 and the magnetic head 149 from being contaminated by dust or moisture intruding from the outside of the housing 110 via the through hole 170.

The hole cover 172 completely covers the through hole 170. According to one aspect, the hole cover 172 is directly attached to the bottom surface of the base plate 111 using an adhesive tape 174 covering the hole cover 172, as shown in the drawing. According to anther aspect, the hole cover is directly attached to the bottom surface of the base plate 111 using an adhesive.

Hereinafter, a noise reduction effect in the hard disk drive having the hole cover 172, blocking an electromagnetic wave will be described by comparing it with the conventional hard disk drive.

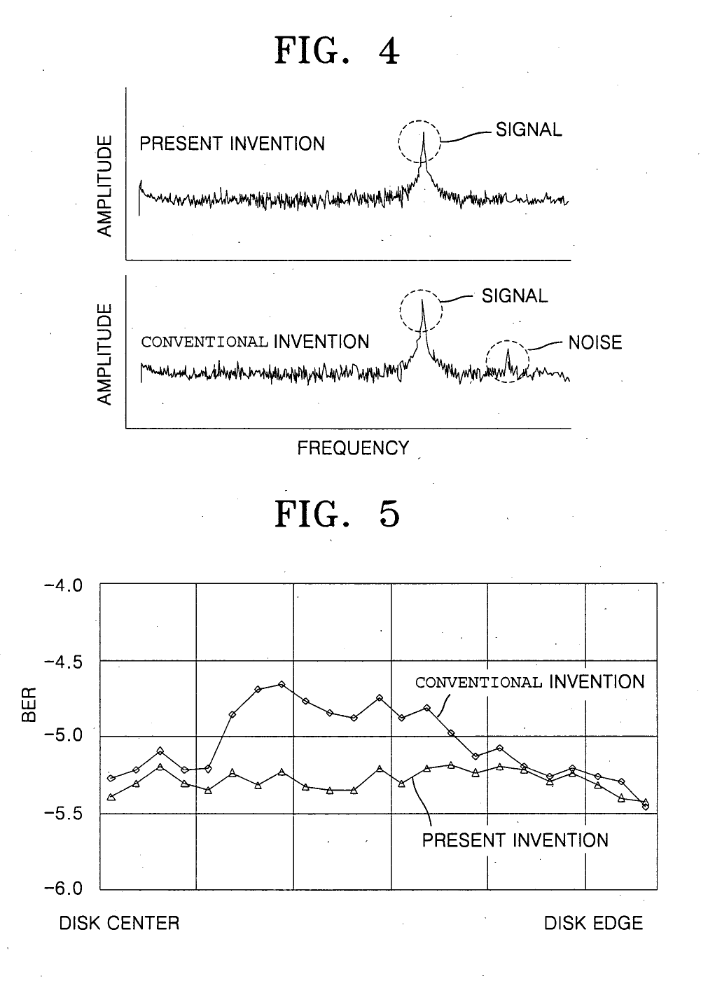

FIG. 4 is a graph showing amplitudes of a reproduction signal and noise in the hard disk drive having the hole cover 172, in comparison with the conventional hard disk drive.

Referring to the graph, in the conventional hard disk drive, significant noise is generated in a frequency area different from a frequency of the reproduction signal due to the electromagnetic wave generated by the PCB. In contrast, in the hard disk drive having the hole cover 172, it can be seen that noise due to the electromagnetic wave is hardly generated.

FIG. 5 is a graph showing a BER of a reproduction signal according to the position of the magnetic head in the hard disk drive having the hole cover 172, in comparison with the conventional hard disk drive.

Referring to the graph, it can be seen that the entire BER in the hard disk drive having the hole cover 172 is relatively lower than that of the conventional invention. Since one of factors determining the BER is a ratio of noise to a reproduction signal, the BER is reduced as the ratio decreases. In particular, it can be see that the BER is definitely improved when the magnetic head, the preamplifier, and the FPCB are disposed in the middle portion of the disk closest to the through hole, that is, the magnetic head is disposed between the central portion and the edge portion of the disk.

As described above, in the hard disk drive having the hole cover 172, the effect of the electromagnetic wave generated by the PCB is reduced or eliminated by the eddy current loss at the hole cover 172 exhibiting electric conductivity. Thus, since the electromagnetic wave is prevented from reaching the magnetic head and preamplifier in the housing, noise due to the electromagnetic wave is reduced, and quality of the reproduction signal is improved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A hard disk drive comprising:
a housing having a base plate and a cover plate;
a spindle motor installed on the base plate;
a disk installed on the spindle motor to store data;
an actuator having a magnetic head to record and/or reproduce data on the disk, that is installed on the base plate, and is pivoted by a voice coil motor;
a hole cover made of a metal plate exhibiting an electric conductivity; and
a printed circuit board installed on a bottom surface of the base plate,
wherein a through hole where servo track information is recorded on a recording surface of the disk is positioned in the base plate, and the hole cover covers the through hole, and is attached to a bottom surface of the base plate to block an electromagnetic wave generated by the printed circuit board from being transferred to an inside of the housing.

2. The hard disk drive as claimed in claim 1, wherein:
eddy current is generated in the hole cover by the electromagnetic wave, and the electromagnetic wave is reduced by energy loss due to the eddy current.

3. The hard disk drive as claimed in claim 1, wherein:
the hole cover is made of an aluminum plate.

4. The hard disk drive as claimed in claim 1, wherein:
the hole cover is attached to the bottom surface of the base plate using an adhesive.

5. The hard disk drive as claimed in claim 1, wherein:
the hole cover is attached to the bottom surface of the base plate using an adhesive tape covering the hole cover.

6. A hard disk drive, comprising:
a base with an opening;
a disk, rotatably installed on the base;
an actuator to write to and read from the disk;
a printed circuit board; and
a hole cover to cover the opening and one of attenuate and block an electromagnetic wave generated by the printed circuit board.

7. The hard disk drive according to claim 6, wherein the hole cover comprises:
a metal plate.

8. The hard disk drive according to claim 7, wherein:
the metal plate is aluminum.

9. The hard disk drive according to claim 6, wherein:
the hole cover is electrically conductive.

10. The hard disk drive according to claim 6, wherein:
the hole cover exhibits an electrical conductivity of predetermined magnitude;
the hole cover exhibits an electrical resistance of predetermined magnitude;
the hole cover has a thickness of predetermined magnitude; and
the hole cover attenuates the electromagnetic wave by eddy current loss.

11. The hard disk drive according to claim 6, wherein:
the hole cover exhibits an electrical conductivity of predetermined magnitude;
the hole cover exhibits an electrical resistance of predetermined magnitude;
the hole cover has a thickness of predetermined magnitude; and
the hole cover blocks the electromagnetic wave by eddy current loss.

12. A base for a hard disk drive including a printed circuit board, the base comprising:
a base plate; and
a hole cover, covering an opening in the base plate, and attenuating an electromagnetic wave generated by the printed circuit board.

13. The base plate according to claim 12, wherein:
the hole cover is an aluminum plate.

14. A hole cover covering an opening in a base of a hard disk drive including a printed circuit board that generates an electromagnetic wave, the hole cover comprising:
a metal plate attenuating the electromagnetic wave due to eddy current loss.

15. The hole cover according to claim 14, wherein:
the metal plate is aluminum.
